(19) United States
(12) Patent Application Publication
(10) Pub. No.: US 2020/0366366 A1
(43) Pub. Date: Nov. 19, 2020

(54) SATELLITE TELECOMMUNICATION SYSTEM WITH TRANSPARENT DIGITAL PROCESSOR AND BEAM HOPPING

(71) Applicant: THALES, COURBEVOIE (FR)

(72) Inventors: Bernard CHARRAT, TOULOUSE (FR); Philippe VOISIN, TOULOUSE (FR); Mathieu DERVIN, TOULOUSE (FR)

(21) Appl. No.: 16/859,978

(22) Filed: Apr. 27, 2020

(30) Foreign Application Priority Data
May 16, 2019 (FR) 1905026

(51) Int. Cl. H04B 7/204; H04B 7/185

(52) U.S. Cl. CPC H04B 7/2041; H04B 7/18515; H04B 7/18513

(57) ABSTRACT

A satellite multibeam telecommunication system includes at least one satellite provided with at least one high-power amplifier, a digital processor, and means for implementing go channel beam hopping, without return channel beam hopping, the digital processor being configured to digitize the return channel beams and aggregate them, the bandwidth of the return channel beams being proportional to the temporal allocation on the go channel beams.

### CROSS-REFERENCE TO RELATED APPLICATIONS

This application claims priority to foreign French patent application No. FR 1905026, filed on May 16, 2019, the disclosure of which is incorporated by reference in its entirety.

### FIELD OF THE INVENTION

The present invention relates to a satellite telecommunication system.

### BACKGROUND

Satellite telecommunication systems are known that have multi-spot (multi-zone) geographic coverage.

The implementation of beam hopping in the go channel of a satellite multibeam telecommunication system makes it possible to provide flexibility or dynamic adaptation in the distribution of the communication capacity (data bit rate) between multiple beams, while optimizing the use of the high-power amplifiers, such as the travelling wave tubes or the solid state power amplifiers, or SSPA, that generate the beams.

A high-power amplifier is an amplifier capable of amplifying up to powers of 10 to 200 W.

However, in the return channel, the use of beam hopping presents drawbacks, such as the reduction of the peak bit rate that is achievable in the return channel given identical terminal specifications, and a cost overhead and an increased weight because the payload also necessitates including the equipment required to perform the return channel beam hopping (such as ferrite switches).

Peak bit rate is understood to mean the maximum bit rate that a user can obtain.

It is known practice not to use return channel beam hopping and then keep a return channel with a static allocation of the resources (frequency band and power) for each beam.

However, in such an embodiment, the ratio of communication capacity between the go channel and the return channel is variable because the capacity of the go channel is adjustable contrary to that of the return channel. Furthermore, the return channel must then be overdimensioned so as not to obtain a capacity ratio that is too low in “hot spots” (zones of high capacity demand) where a lot of beam hopping resources would be allocated to the go channel.

### SUMMARY OF THE INVENTION

One aim of the invention is to overcome the abovementioned drawbacks.

So, there is proposed, according to one aspect of the invention, a satellite multibeam telecommunication system comprising at least one satellite provided with at least one high power amplifier, a digital processor, and means for implementing go channel beam hopping, without return channel beam hopping, the digital processor being configured to digitize the return channel beams and aggregate them, the bandwidth of the return channel beams being proportional to the temporal allocation on the go channel beams.

Thus, a user isolated in a beam does not have his or her peak bit rate reduced in the return channel, and the beam hopping mechanisms are not necessary in the return channel.

In one embodiment, the high-power amplifier is a travelling wave tube or a solid state power amplifier.

According to one embodiment, the digital processor is a transparent digital processor or a regenerative digital processor.

In one embodiment, the system comprises, for each return channel beam, an amplifier upstream of the processor.

Thus, the signal level is sufficient at the output of the amplifier for the rest of the processing.

According to one embodiment, the system comprises, for each return channel beam, a frequency converter downstream of the amplifier and upstream of the digital processor.

Thus, the signal frequency at the output of the frequency converter is compatible with the digital processor.

In one embodiment, the system comprises, for each return channel beam, a multiplexer downstream of the frequency converter and upstream of the digital processor.

Thus, the number of inputs used on the digital processor is reduced.

According to one embodiment, the system comprises, in the return channel, downstream of the digital processor, a frequency converter, a power amplifier and a transmission antenna feed, disposed in series.

Thus, the signal is frequency-converted and amplified so that the communication with the user is possible.

Also proposed, according to another aspect of the invention, is a method for managing a digital processor of a satellite of a satellite multibeam telecommunication system with go channel beam hopping and without return channel beam hopping, wherein the return channel beams are digitized and they are aggregated, the bandwidth of the return channel beams being proportional to the temporal allocation on the go channel beams.

### BRIEF DESCRIPTION OF THE DRAWINGS

The invention will be better understood on studying a few embodiments described as nonlimiting examples and illustrated by the attached drawings in which:

FIG. 1 schematically illustrates embodiments of a system according to various embodiments of the invention;

FIG. 2 schematically illustrates embodiments of a system according to various embodiments of the invention;

FIG. 3 schematically illustrates embodiments of a system according to various embodiments of the invention;

FIG. 4 schematically illustrates embodiments of a system according to various embodiments of the invention;

FIG. 5 schematically illustrates embodiments of a system according to various embodiments of the invention; and

FIG. 6 schematically illustrates embodiments of a system according to various embodiments of the invention.

Throughout the figures, the elements that have identical references are similar.

### DETAILED DESCRIPTION

In the present description, the embodiments described are nonlimiting, and the features and functions that are well known to the person skilled in the art are not described in detail.

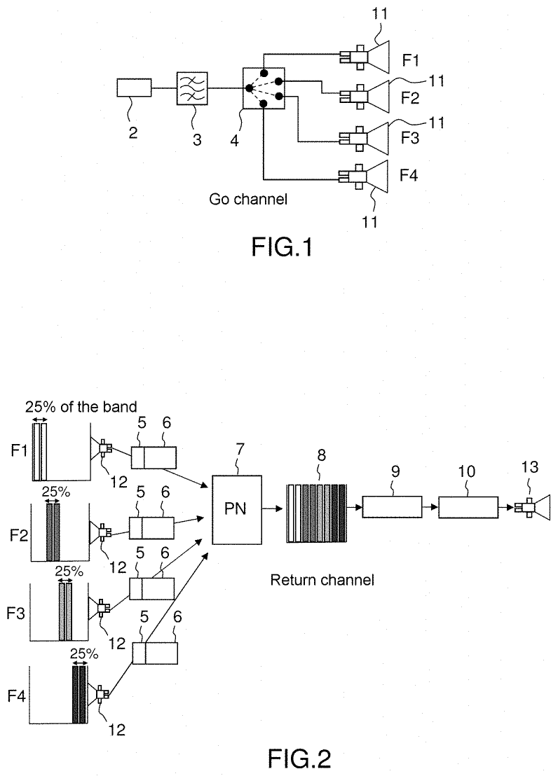

FIG. 1 schematically represents a payload with beam hopping go channel in a scheme for sharing the resource of a tube of 1 to N beams, in this particular case four beams F1, F2, F3, F4 in the examples represented in a nonlimiting manner. Indeed, the invention applies regardless of the number N of beams, but is illustrated with 4 beams in the present application.

The go channel payload comprises, disposed in series, a tunable high-power amplifier 2, a filter 3, and a beam hopping device 4 (for example 3 ferrite switches 4, on two stages) making it possible to distribute, by switching, the allocation over the different beams F1, F2, F3, F4, respectively associated with respective transmission antenna feeds 11.

The high-power amplifier can be a travelling wave tube or a solid state power amplifier.

In the return channel, each beam F1, F2, F3, F4 is assigned the maximum band necessary to cover the maximum case of use of this go channel beam. The band received at the payload level is amplified and frequency-converted in order to be compatible with the input frequency band of a digital processor PN.

The digital processor can be a transparent digital processor or a regenerative digital processor.

The digital processor PN then aggregates the bands of the different beams that are really used pro rata with the temporal sharing done at the “beam hopping” level for the go channel.

The principle is illustrated in FIG. 2 with the assumption of an equi-temporal go channel sharing assigning, as in this example represented, 25% of the time to each of the four beams F1, F2, F3, F4.

Each set of amplifier 5 and frequency converter 6 for each reception beam receives one of the beams received by a reception antenna feed 12 and adapts it to transmit it to a respective input of the digital processor PN which then aggregates the bands of the different beams that are really used pro rata to the temporal sharing done at the “beam hopping” level for the go channel. In this particular case, the pro rata share is 25% for each frequency band as illustrated on the output signal 8 of the digital processor PN.

The output signal 8 of the digital processor PN is then converted by a converter 9 so as to raise the frequencies, then amplified by a power amplifier 10, and transmitted by a transmission antenna feed 13 to the final user.

In the figures, the choice was made to position the four beams F1, F2, F3, F4 on different frequencies for comprehension purposes (in a nonlimiting manner), but the four beams F1, F2, F3, F4 can be positioned or not on the same frequency band, because, after the digitization thereof in the digital processor PN, the frequency at the output of the digital processor PN is chosen so as to juxtapose the corresponding frequency bands in the band available for the return channel. It is therefore only after the digital processor PN that these frequency bands must be juxtaposed.

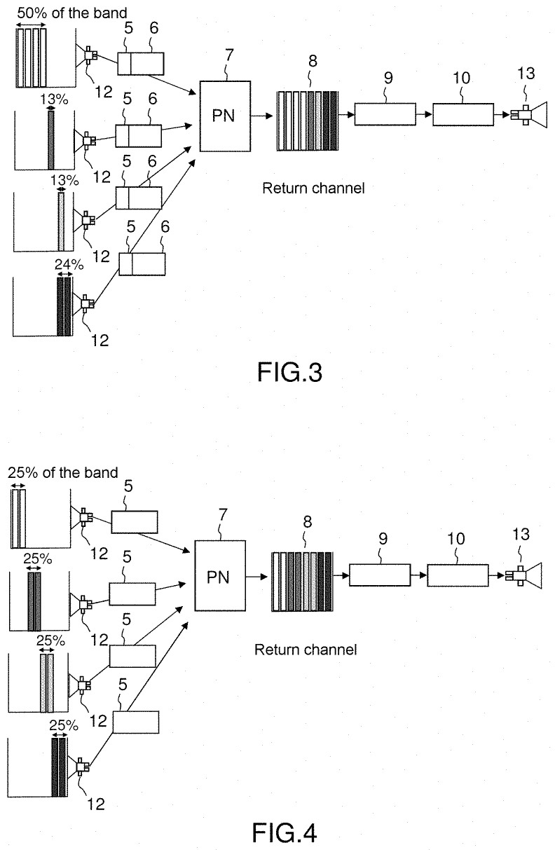

FIG. 3 illustrates the same system, with operation in which a different, non equi-temporal sharing is effected in the go channel. In this particular case, the system is represented with a different, non-equi-temporal sharing in the go channel assigning 50% of the time to the beam F1 spot, 13% to the beam F2 spot, 13% to the beam F3 spot, and 24% to the beam F4 spot. In this particular case, there is, after the digital processor PN, the signal 8 comprising the sum of the band of the input signals temporally pro rata of the transmission of the go channel.

The present invention makes it possible to not need return channel beam hopping, and makes it possible to keep a constant go/return capacity ratio even by varying the go channel temporal sharing percentage.

The present invention also makes it possible not to reduce the peak bit rate accessible to a user, and requires a limited level of additional processing for the digital processor PN.

For example, in a scenario where 50% of the beams have high demand and 50% have low demand, 1-to-4 beam hopping is associated for the low demand beams and no beam hopping is associated for the others (therefore no temporal sharing). In this case, for 100 GHz of frequency band used in the go channel for the beams with high demand, 1/4, i.e. 25 GHz of frequency band, is used in the go channel for the beams with low demand. And therefore also there is a go channel/return channel frequency band ratio demand of 1/3 with the possibility of allocating, for the beams with low demand, all the capacity in just one of the four associated beams if necessary (temporal sharing between the 4 beams being able to assign up to all the capacity to a single beam).

In the case of the invention in the return channel, there will be 100*1/3+25*4/3=66.66 GHz which are added to the go channel frequency band of 100+25=125 GHz, i.e. 192.66 GHz of total frequency band to be processed by the digital processor PN.

In the case that minimizes the bandwidth to be processed for the digital processor PN with return channel beam hopping, there is 100*1/3+25*1/3=41.66 GHz which are added to the go channel frequency band of 100+25=125 GHz, i.e. 166.66 GHz of total frequency band to be processed by the digital processor PN. In other words, a moderate band increase of 15% to be processed by the digital processor PN in the context of the invention with the benefits for an isolated user in a beam not to have his or her peak bit rate reduced in the return channel, and for the beam hopping mechanisms not to be necessary in the return channel.

Thus, when N spots (in this particular case 4 in the examples described in a nonlimiting manner) are associated in go channel beam hopping, the principle consists in using the digital processor PN in order to extract, for each spot of index i, the Ni % of the total accessible return channel band which is actually used, before being frequency multiplexed. The coefficients Ni comply with the constraint ΣNi %=100%, and their distribution is equivalent to the temporal distribution of the resources on the go channel.

FIG. 4 represents a system according to one aspect of the invention, similar to that of FIGS. 2 and 3, with the assumption of an equi-temporal go channel sharing assigning, as in this example represented, 25% of the time to each of the four beams F1, F2, F3, F4 as for FIG. 2.

In this variant, the reception frequency band is directly compatible with the input frequencies of the digital processor PN, so the frequency conversion step is not necessary, and the system therefore has no converter 6.

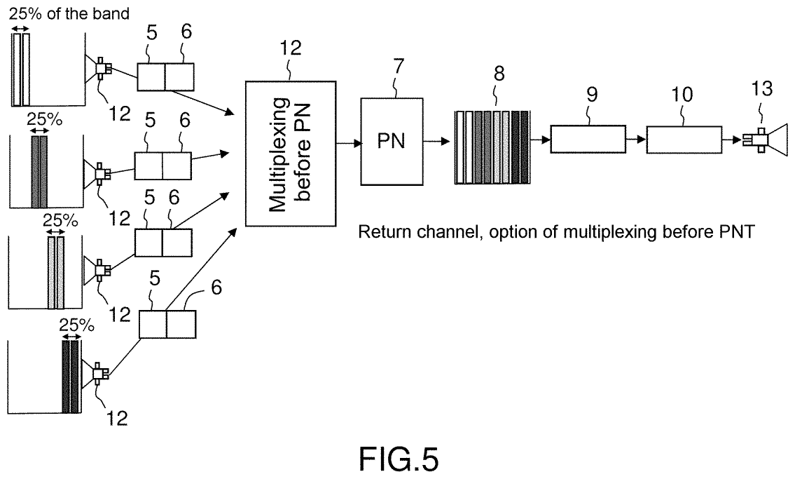

FIG. 5 represents a system according to one aspect of the invention, similar to that of FIGS. 2 and 3, with the assumption of an equi-temporal go channel sharing assigning, as in this example represented, 25% of the time to each of the four beams F1, F2, F3, F4, as for FIG. 2.

In this variant, the frequency bands corresponding to the different beams F1, F2, F3, F4 can be multiplexed by a multiplexer 14 using filters that make it possible to limit the number of inputs necessary at the digital processor PN level, in this particular case just one input, but in a nonlimiting manner.

This variant introduces a filter to multiplex the four beams F1, F2, F3, F4 upstream of the PN in order to limit the number of inputs thereof, in this case these bands must not be overlaid for the multiplexing to be possible.

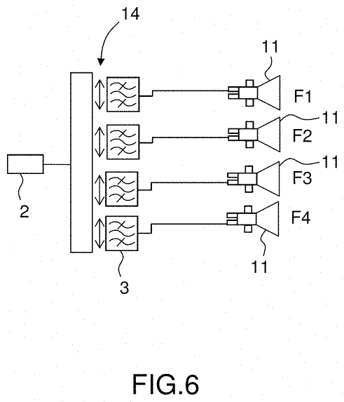

As a variant, as illustrated in FIG. 6, it is easy to adapt the invention to apply it to the case of go channel band flexibility (filter that can be adapted in terms of frequency band 12 instead of temporal flexibility 4) which also makes it possible to maximize the high power amplifier use (for example a payload with, in the go channel, an output demultiplexer that is flexible and adaptable in terms of frequency band in a scheme for sharing the resource of a high-power amplifier from 1 to N beams.

1. A satellite multibeam (F1, F2, F3, F4) telecommunication system comprising at least one satellite provided with at least one high-power amplifier, a digital processor (PN), and means for implementing go channel beam hopping, without return channel beam hopping, the digital processor (PN) being configured to digitize the return channel beams and aggregate them, the bandwidth of the return channel beams (F1, F2, F3, F4) being proportional to the temporal allocation on the go channel beams (F1, F2, F3, F4).

2. The system according to claim 1, wherein the high-power amplifier is a traveling wave tube or a solid state power amplifier.

3. The system according to claim 1, wherein the digital processor is a transparent digital processor or a regenerative digital processor.

4. The system according to claim 1, comprising, for each return channel beam (F1, F2, F3, F4), an amplifier upstream of the digital processor (PN).

5. The system according to claim 4, comprising, for each return channel beam, a frequency converter downstream of the amplifier and upstream of the digital processor (PN).

6. The system according to claim 4, comprising, for each return channel beam, a multiplexer downstream of the frequency converter and upstream of the digital processor (PN).

7. The system according to claim 1, comprising, in the return channel, downstream of the digital processor (PN), a frequency converter, a power amplifier and a transmission antenna feed, disposed in series.

8. A method for managing a digital processor (PN) of a satellite of a satellite multibeam telecommunication system with go channel beam hopping and without return channel beam hopping, wherein the return channel beams are digitized and they are aggregated, the bandwidth of the return channel beams (F1, F2, F3, F4) being proportional to the temporal allocation on the go channel beams (F1, F2, F3, F4).
